(19) United States
(12) Patent Application Publication
(10) Pub. No.: US 2012/0206467 A1
(43) Pub. Date: Aug. 16, 2012

(54) DRIVING METHOD FOR BISTABLE DISPLAY DEVICE AND DRIVING DEVICE THEREOF

(75) Inventors: Chien-Chia Shih, Hsinchu City (TW); Gin-Yen Lee, Hsinchu County (TW)

(73) Assignee: NOVATEK MICROELECTRONICS CORP., Hsinchu (TW)

(21) Appl. No.: 13/099,378

(22) Filed: May 3, 2011

(30) Foreign Application Priority Data
Feb. 15, 2011 (TW) 100104916

(51) Int. Cl. G09G 5/36; G09G 3/34; G09G 5/00

(52) U.S. Cl. 345/545; 345/204; 345/107

(57) ABSTRACT

A driving method adapted to a bistable display including a display panel is provided. The driving method includes following steps. A first area data and a second area data respectively received are sequentially stored in a first queue and a second queue, respectively. A first area image corresponding to the first area data and a second area image corresponding to the second area data are sequentially calculated. The first area image is displayed on the display panel during a first frame period of a first period, and the second area image is displayed on the display panel during a second first frame period of the first period. After the first period, the first area image on the display panel is in a stable state. After a summation time of first period and the second frame period, the second area image on the display panel is in a stable state.

### CROSS-REFERENCE TO RELATED APPLICATION

This application claims the priority benefit of Taiwan application serial no. 100104916, filed Feb. 15, 2011. The entirety of the above-mentioned patent application is hereby incorporated by reference herein and made a part of this specification.

### BACKGROUND OF THE INVENTION

1. Field of the Invention

The invention relates to a display device and a driving method thereof. Particularly, the invention relates to a bistable display device and a driving method thereof.

2. Description of Related Art

Along with quick development of digital media content and display technology, flat panel displays have become main interfaces between human and digital information. In recent years, e-paper displays (EPDs) are quickly developed, and since the EPD has a characteristic of displaying different digital contents on a same digital platform, a user can easily obtain different digital content, and it has a trend of gradually replacing a conventional paper reading habit.

On the other hand, compared to a display device such as a liquid crystal display (LCD), since the EPD has a bistable characteristic, it requires a driving voltage only when a frame is updated, so that power consumption thereof is relatively less. However, although the EPD has a plurality of advantages, an image updating time of the EPD is rather long, so that a dynamic image effect cannot be achieved, and it is unsatisfactory in interactive applications, for example, displays for pen tracking and video files. Therefore, it is required to develop a technique to increase a refreshing rate of the EPD.

### SUMMARY OF THE INVENTION

The invention is directed to a bistable display, a driving method thereof and a driving device thereof, which are capable of shortening a frame updating time.

The invention provides a driving method adapted to a bistable display. The bistable display includes a display panel. The driving method includes following steps. A respectively received first area data and a second area data are sequentially stored in a first queue and a second queue, respectively. A first area image corresponding to the first area data and a second area image corresponding to the second area data are sequentially calculated. The first area image is displayed on the display panel during a first frame period of a first period, and the second area image is displayed on the display panel during a second frame period of the first period. After the first period is passed, the first area image on the display panel is in a stable state. After a summation time of the first period and the second frame period is passed, the second area image on the display panel is in the stable state.

In an embodiment of the invention, the step of displaying the first area image on the display panel during the first frame period of the first period comprises: storing the first area image into an event buffer; copying the first area image to a current frame buffer to form a first frame image; and comparing the first frame image with a previous frame image to display the first area image on the display panel according to a first comparison result during the first frame period.

In an embodiment of the invention, the step of displaying the second area image on the display panel during the second frame period of the first period comprises: updating the event buffer according to the second area image; copying the second area image to the current frame buffer to form a second frame image, where the second frame image comprises the first area image and the second area image; and comparing the first frame image with the previous frame image to display the second area image on the display panel according to a second comparison result during the second frame period.

In an embodiment of the invention, the step of updating the event buffer according to the second area image comprises storing the second area image into the event buffer.

In an embodiment of the invention, the step of updating the event buffer according to the second area image comprises deleting the first area image in the event buffer.

In an embodiment of the invention, the previous frame image is stored in a previous frame buffer.

In an embodiment of the invention, the driving method further includes following steps. After the first period is passed, the first area image is copied to the previous frame buffer to update the previous frame buffer. After the summation time of the first period and the second frame period is passed, the second area image is copied to the previous frame buffer to update the previous frame buffer.

In an embodiment of the invention, when the first frame image is different to the previous frame image, the first comparison result is output according to a look-up table.

In an embodiment of the invention, the driving method further comprises setting the first queue to an idle state.

In an embodiment of the invention, the first period is an integer multiple of the first frame period.

In an embodiment of the invention, the first area data includes at least one of start point coordinates, an image width, an image length and image pixels of the first area image.

The invention provides a driving device adapted to a bistable display. The bistable display includes a display panel. The driving device includes a first queue, a second queue and a controller. The controller sequentially stores a respectively received first area data and a second area data in the first queue and the second queue, respectively, and sequentially calculates a first area image corresponding to the first area data and a second area image corresponding to the second area data. Then, the controller controls the display panel to display the first area image during a first frame period of a first period, and controls the display panel to display the second area image during a second frame period of the first period. After the first period is passed, the first area image on the display panel is in a stable state. After a summation time of the first period and the second frame period is passed, the second area image on the display panel is in the stable state.

In an embodiment of the invention, the driving device further includes a memory coupled to the controller. The memory includes an event buffer and a current frame buffer. The event buffer stores the first area image. The controller copies the first area image to the current frame buffer to form a first frame image. Then, the controller compares the first frame image with a previous frame image to display the first area image on the display panel according to a first comparison result during the first frame period.

In an embodiment of the invention, the controller further updates the event buffer according to the second area image, and copies the second area image to the current frame buffer to form a second frame image, wherein the second frame image includes the first area image and the second area image. Then, the controller compares the second frame image with the previous frame image to display the second area image on the display panel according to a second comparison result during the second frame period.

In an embodiment of the invention, the controller stores the second area image in the event buffer.

In an embodiment of the invention, the controller deletes the first area image in the event buffer.

In an embodiment of the invention, the memory further includes a previous frame buffer, and the previous frame image is stored in the previous frame buffer.

In an embodiment of the invention, after the first period is passed, the controller copies the first area image to the previous frame buffer to update the previous frame buffer. After the summation time of the first period and the second frame period is passed, the controller copies the second area image to the previous frame buffer to update the previous frame buffer.

In an embodiment of the invention, the driving device further includes a look-up table. When the first frame image is different to the previous frame image, the controller outputs the first comparison result according to the look-up table.

In an embodiment of the invention, the controller further sets the first queue to an idle state.

Besides, the invention further provides a bistable display including the aforementioned driving device.

In an embodiment of the invention, the bistable display is an e-paper display (EPD).

According to the above descriptions, the first area image and the second area image are sequentially calculated according to the corresponding first area data and the second area data stored in the first queue and the second queue, so that after the display panel displays the first area image for a period of time and before the first area image reaches the stable state, the display panel starts to display the second area image. In this way, the whole image updating time is shortened.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a bistable display according to an embodiment of the invention.

FIG. 2A and FIG. 2B are diagrams illustrating driving waveforms of a driving device 120 according to an embodiment of the invention.

FIG. 2C is an enlarged schematic diagram of a frame period T1 of FIG. 2A.

FIG. 3 is a flowchart illustrating a driving method according to an embodiment of the invention.

FIG. 4 is a schematic diagram of an area image according to an embodiment of the invention.

FIG. 5 is a detailed flowchart of a driving method of FIG. 3.

FIG. 6A to FIG. 6G are schematic diagrams of a display panel varied along with time.

FIG. 7 is another flowchart illustrating a driving method of FIG. 3.

FIG. 8A to FIG. 8G are schematic diagrams of the driving method of FIG. 7.

### DETAILED DESCRIPTION OF DISCLOSED EMBODIMENTS

In the following embodiments, an e-paper display (EPD) is taken as an example for descriptions, though those skilled in the art should understand that the EPD is not used to limit the invention.

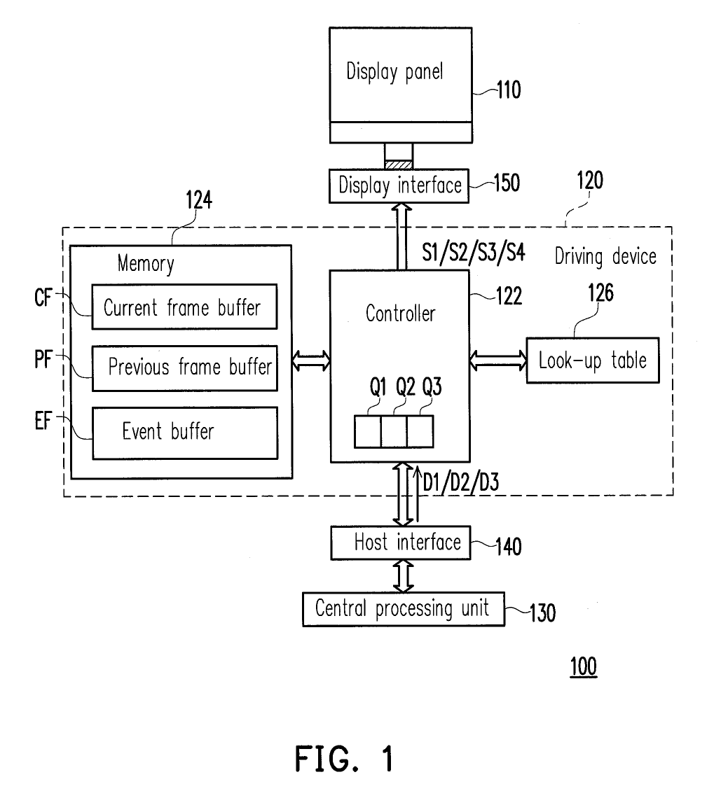

FIG. 1 is a schematic diagram of a bistable display according to an embodiment of the invention. Referring to FIG. 1, the bistable display 100 of the embodiment includes a display panel 110 and a driving device 120. The driving device 120 includes a queue Q1, a queue Q2 and a controller 122. The controller 122 is, for example, a timing controller, which is used for controlling input and output timings. The queue Q1 and the queue Q2 are, for example, disposed in the controller 122, though in other embodiments, the queue Q1 and the queue Q2 can also be disposed at other places in the driving device 120, and are unnecessary to be disposed in the controller 122. Moreover, the driving device 120 of the present embodiment also includes a queue Q3, and although the number of the queues is three, the invention is not limited thereto.

Moreover, the driving device 120 further includes a memory 124 and a look-up table 126. The memory 124 is coupled to the controller 122 and includes a current frame buffer CF and a previous frame buffer PF, where the current frame buffer CF is used to temporarily store a frame image to be currently displayed, and the previous frame buffer PF is used to temporarily store an image which has been completely displayed on the display panel 110. Moreover, the look-up table 126 is used to record all possible driving waveforms, where the driving waveforms are transmitted to the display panel 110 through a display interface 150 for driving the display panel 110, so that the display panel 110 displays a corresponding frame image. Further, the look-up table 126, for example, records binary data of 00 or 11 representing data of a 0V driving waveform, 01 representing data of a +15V driving waveform and 10 representing data of a −15V driving waveform.

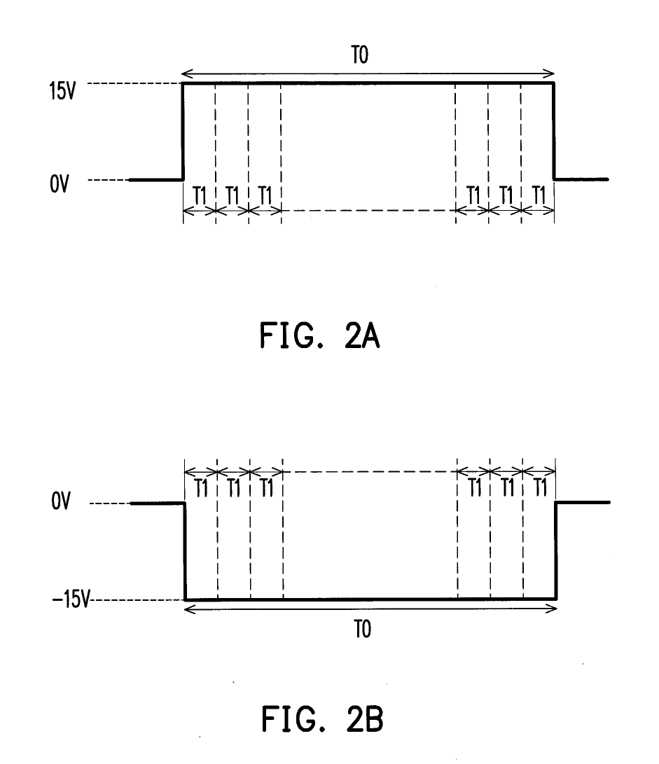

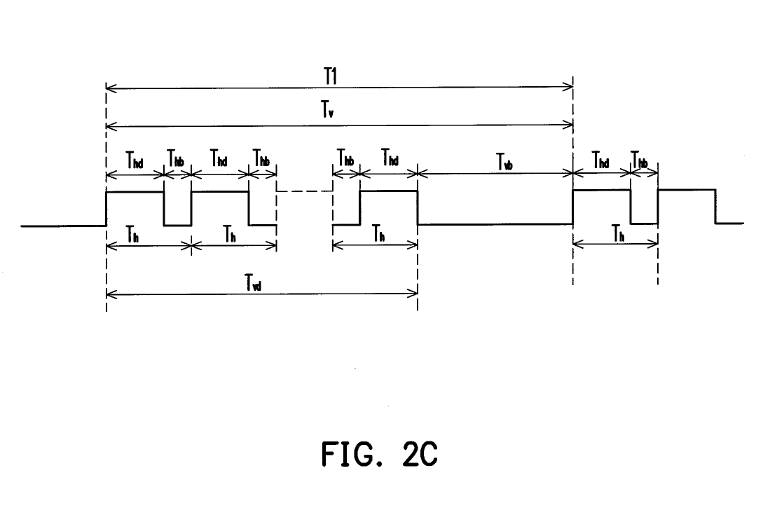

FIG. 2A and FIG. 2B are diagrams illustrating driving waveforms of the driving device 120 according to an embodiment of the invention. A frame period T1 represents an executing time of a frame (which is about 20 ms), and a period T0 is an integer multiple of the frame period T1 (which is about 260 ms), i.e. T0=nT1, and n is a positive integer. In the present embodiment, the display panel 110 of the bistable display 100 generates different gray levels by mixing black particles and white particles (not shown), so as to achieve an effect of displaying a frame image. The period T0 represents a time required to achieve a stable state of a frame image displayed on the display panel 110. Since distribution of the black particles and the white particles is controlled by a polarity and a magnitude of a voltage, and a period of time has to be required for these particles reaching suitable positions to display a predetermined gray level effect, the period T0 is required for the frame image displayed on the display panel 110 reaching the stable state.

As shown in FIG. 2A and FIG. 2B, the driving waveform of the present embodiment has three different potentials of a positive voltage, a ground voltage and a negative voltage, which are respectively +15V, 0V and −15V. Moreover, the black particles and the white particles of the display panel 110 are, for example, particles respectively carrying positive charges and negative charges. Referring to FIG. 2A, when the display panel 110 is to display a black image, the driving device 120 outputs the +15V driving waveform to push the black particles carrying the positive charges to the top of the display panel 110, so that the display panel 110 displays the black image. However, as described above, since movement of the black particles and the white particles requires a certain time, i.e. during the frame period T1, an observer can only view a light gray color, the driving device 120 has to continually output the +15V driving waveform during the period T0 to drive the black particles and the white particles to suitable positions to display the black image. In other words, in the present embodiment, at least the period T0 is required for each frame image reaching the stable state to display the predetermined gray level effect. On the other hand, as shown in FIG. 2B, when the display panel 110 is to display a white image, the driving device 120 outputs the −15V driving waveform to push the white particles carrying the negative charges to the top of the display panel 110, so that the display panel 110 displays the white image. Similarly, the driving device 120 has to continually output the −15V driving waveform during the period T0 to drive the black particles and the white particles to suitable positions to display the white image.

In addition, FIG. 2C is an enlarged schematic diagram of the frame period T1 of FIG. 2A. As shown in FIG. 2C, the frame period T1 is equivalent to a vertical scan period Tv, i.e. one vertical scan period Tv is just equal to the frame period T1 that the controller 122 executes one frame image. In detail, the vertical scan period Tv includes a vertical display period Tvd and a vertical non-display period Tvb. The vertical display period Tvd includes a plurality of horizontal scan periods Th, and each of the horizontal scan periods Th includes a horizontal display period Thd and a horizontal non-display period Thb.

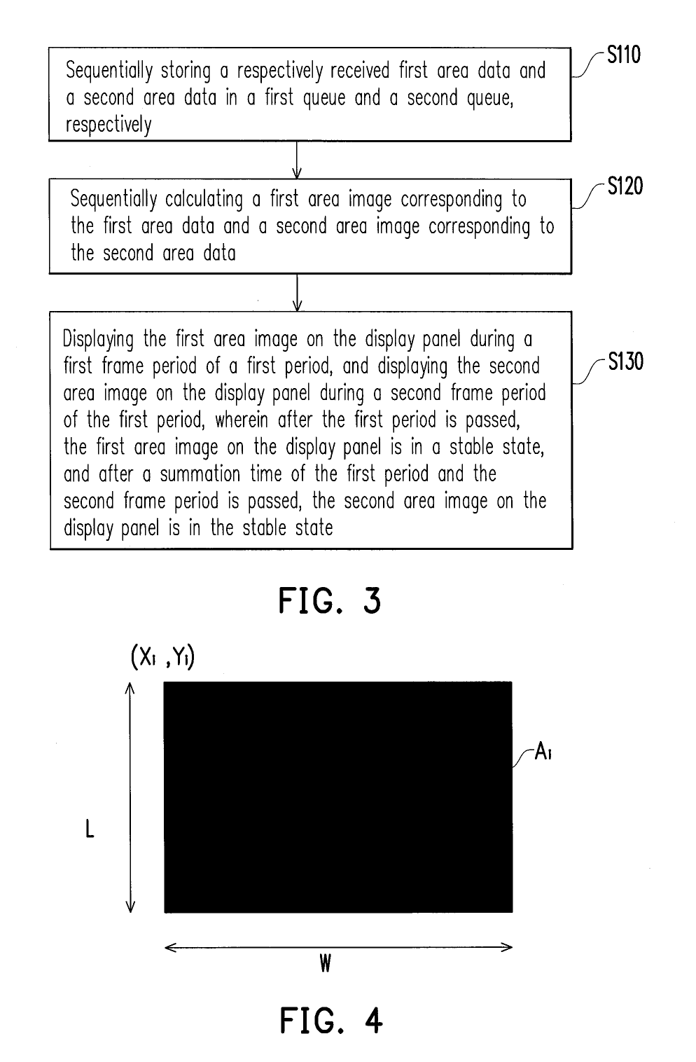

FIG. 3 is a flowchart illustrating a driving method according to an embodiment of the invention. Referring to FIG. 1 to FIG. 3, the driving method of the present embodiment is executed by the driving device 120. The controller 122 sequentially stores sequentially received area data D1 and area data D2 in the queue Q1 and the queue Q2, respectively (step S110). In the present embodiment, the area data D1 and the area data D2 are, for example, data of an area image Ai of FIG. 4 transmitted to the driving device 120 by a central processing unit (CPU) 130 through a host interface 140 of FIG. 1, where the data has a format of the area image Ai, and the format of the area image Ai includes at least one of start coordinates (Xi, Yi), an image width W, an image length L and image pixels.

Then, the controller 122 of FIG. 1 sequentially calculates area images respectively corresponding to the area data D1 in the queue Q1 and the area data D2 in the queue Q2 (step S120). Then, the controller 122 controls the display panel 110 to display the area image corresponding to the area data D1 during the frame period T1 of the period T0 (shown in FIG. 2A), and controls the display panel 110 to display the area image corresponding to the area data D2 during a next frame period T1 of the period T0. Namely, the display panel 110 starts to display the second area image before the first area image reaches the stable state. After the period T0 is passed, the area image corresponding to the area data D1 is in a stable state on the display panel 110, and after a summation time of the period T0 and the frame period T1 (i.e. T0+T1) is passed, the area image corresponding to the area data D2 is in the stable state on the display panel 110 (step S130). Moreover, during a process of executing the step S130, the controller 120 may first temporarily store the area image corresponding to the area data D1 in an event buffer EF of the memory 124, and then transmit it to the current frame buffer CF. The above content is a brief description of the driving method of the embodiment, and the driving method of the embodiment is described in detail below.

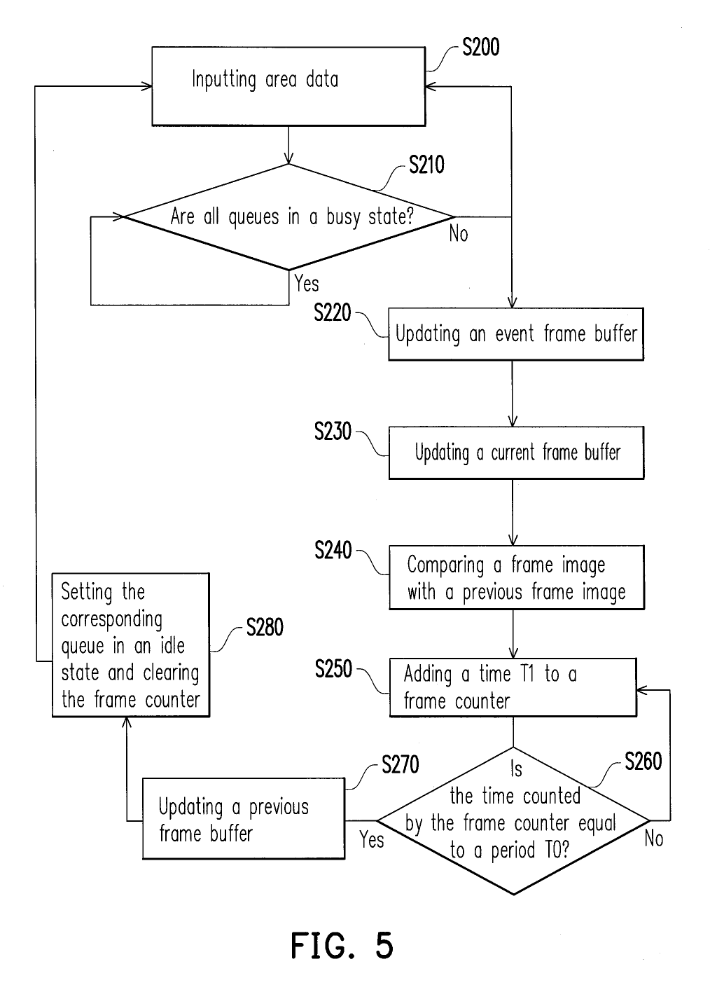

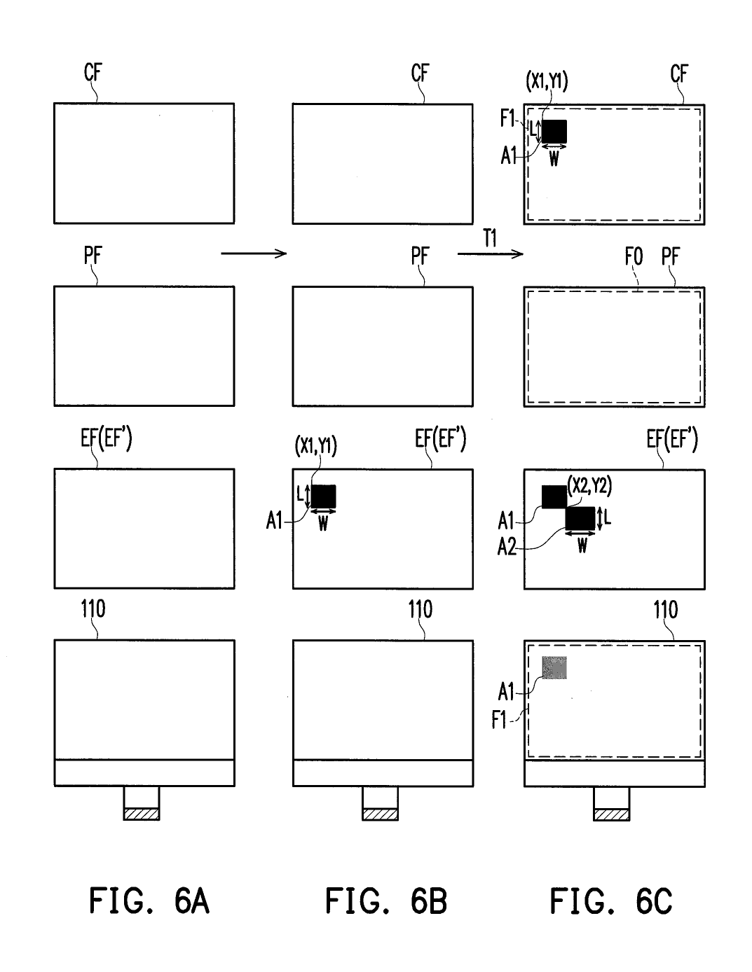

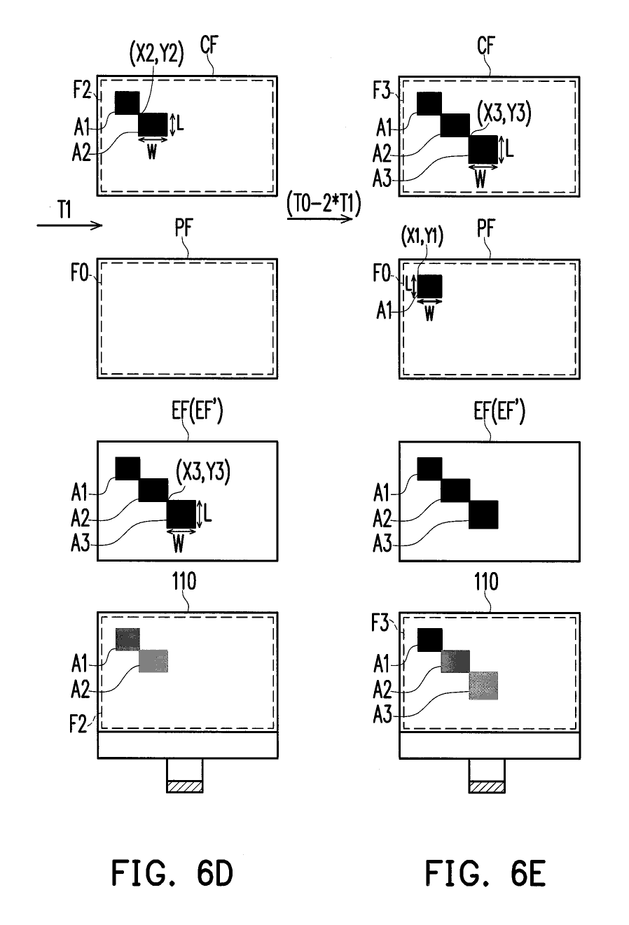

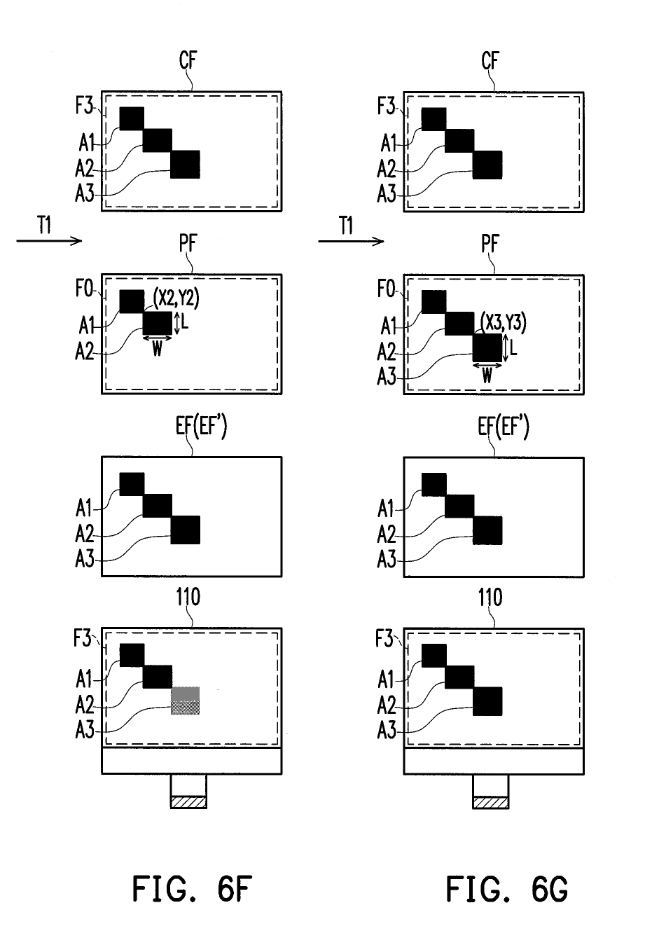

FIG. 5 is a detailed flowchart of the driving method of FIG. 3, and FIG. 6A to FIG. 6G are schematic diagrams of a display panel varied along with time. Further, in FIG. 6A-FIG. 6G, variation processes of the display panel 110, the current frame buffer CF, the previous frame buffer PF and the event buffer EF along with time are illustrated, where the event buffer EF of the present embodiment is an event frame buffer EF′. In other words, the event buffer EF of the present embodiment can store one frame image. As shown in FIG. 6A, it is assumed that the display panel 110, the current frame buffer CF, the previous frame buffer PF and the event frame buffer EF′ are all in the idle state at the beginning, and when the CPU 130 is about to continually display three area images A1-A3 (shown in FIG. 6E-6G) on the display panel 110, the CPU 130 first transmits the area data D1 to the controller 122 of FIG. 1 (step S200), where the area data D1 includes image start coordinates (X1, Y1), an image width W and an image length L.

Referring to FIG. 1 and FIGS. 6A-6B, the controller 122 determines whether all of the queues Q1-Q3 are in a busy state (step S210). When any of the queues Q1-Q3 (for example, the queue Q1) is in the idle state, the controller 122 uses the queue Q1 to temporarily store the area data D1. Then, the controller 122 calculates a corresponding address of the area data D1 according to the area data D1 to obtain the area image A1, and stores the areas image A1 into the event frame buffer EF′ pixel by pixel (referring to step S220 and FIG. 6B).

Then, the controller 122 copies the area image A1 from the event frame buffer EF′ to the current frame buffer CF during the vertical non-display period Tvb (shown in FIG. 2C) to form a frame image F1 (referring to step S230 and FIG. 6C). Meanwhile, a frame counter (not shown) corresponding the frame image F1 in the controller 122 starts to count, and the controller 122 compares the frame image F1 in the current frame buffer CF with a previous frame image F0 in the previous frame buffer PF during the horizontal display time Thd in the vertical display time Tvd (step S240). When the frame image F1 and the previous frame image F0 correspond to a same data value at the same pixel, the controller 122 outputs a comparison result S1 to the display panel 110, where the comparison result S1 is, for example, the 0V driving waveform of FIG. 2A. Moreover, when the frame image F1 and the previous frame image F0 correspond to different data values at the same pixel, the controller 122 outputs a comparison result S2 to the corresponding pixel on the display panel 110 according to the look-up table 126, where the comparison result S2 is, for example, the 15V driving waveform of FIG. 2A. Moreover, the display panel 110 starts to display the area image A1 during the frame period T1 (about 20 ms). As shown in FIG. 6C, after the frame period T1 is passed, the observer may view the area image A1 with a light gray color in the display panel 110. Besides, the frame counter (not shown) corresponding the frame image F1 is added by a time T1 (step S250).

On the other hand, the controller 122 may also synchronously execute the steps S210-S220 at any time for processing a second area image A2. Namely, when one of the queues Q1-Q3 (for example, the queue Q2) is in the idle state, the controller 122 stores the second received area data D2 in the queue Q2, and calculates the area image A2 corresponding to the area data D2, so as to update the event frame buffer EF′ according to the area image A2 (referring to the step S220 and FIG. 6C), by which the area image A2 is, for example, copied to the event frame buffer EF′. Further, the controller 122 calculates the area image A2 according to start coordinates (X2, Y2), the image width W and the image length L of the area data D2. Namely, the controller 122 calculates a corresponding address of the area image A2 according to the area data D2, and stores the areas image A2 into the event frame buffer EF′ pixel by pixel. According to the above descriptions, it is known that at some moments, although processing objects of the step S220 and the step S230 are different (for example, the area image A2 and the area image A1 are respectively processed), the executing time thereof is partially overlapped, so that the image processing time is saved.

Then, the controller 122 repeats the steps S230 and S240 in allusion to the area image A2. In the step S230, the controller 122 copies the area image A2 of FIG. 6C to the current frame buffer CF of FIG. 6D to form a frame image F2, where the frame image F2 includes the area image A1 and the area image A2. In detail, the controller 122 copies the area image A2 from the event frame buffer EF′ to the current frame buffer CF during the vertical non-display period Tvb (shown in FIG. 2C) to form the frame image F2. Meanwhile, a frame counter (not shown) corresponding the frame image F2 in the controller 122 starts to count. Then, in the step S240, the controller 122 compares image pixels of the frame image F2 in the current frame buffer CF with image pixels of the previous frame image F0 in the previous frame buffer PF during a next horizontal display time Thd in the vertical display time Tvd. If data values of the corresponding pixels are the same, the corresponding displayed image is maintained unchanged (i.e. the 0V driving waveform is transmitted to the display panel 110). If data values of the corresponding pixels are different, the look-up table 126 is used to transmit the driving waveform (for example, the +15V driving waveform) of the corresponding address to the display panel 110. In the present embodiment, since the frame image F2 is different to the previous frame image F0 in the previous frame buffer PF, the controller 122 outputs a comparison result S3 to a corresponding position of the display panel 110, and the display panel 110 starts to display the area image A2 during the next frame period T1 (referring to FIG. 6D). Besides, the frame counter (not shown) corresponding the frame image F2 is added by a time T1 (step S250). Since now the area image A1 has been continually displayed for two frame periods T1, the color of the area image A1 is deeper than that of the area image A2.

Similarly, the controller 122 may also synchronously execute the steps S210 and S220 at any time for processing a third area image A3. Namely, when one of the queues Q1-Q3 (for example, the queue Q3) is in the idle state, the controller 122 stores the third received area data D3 in the queue Q3, and calculates the area image A3 corresponding to the area data D3, so as to update the event frame buffer EF′ according to the area image A3 (referring to the step S220 and FIG. 6D). Further, the controller 122 calculates the area image A3 according to start coordinates (X3, Y3), the image width W and the image length L of the area data D3. According to the above descriptions, it is known that at some moments, although processing objects of the step S220 and the step S230 are different (for example, the area image A3 and the area image A2 are respectively processed), the executing time thereof is partially overlapped, so that the image processing time is saved.

Then, the controller 122 copies the area image A3 from the event frame buffer EF′ to the current frame buffer CF during the vertical non-display period Tvb (shown in FIG. 2C) to form the frame image F3 (referring to the step S230 and FIG. 6E). Meanwhile, a frame counter corresponding the frame image F3 in the controller 122 starts to count, and the controller 122 compares the frame image F3 in the current frame buffer CF with the previous frame image F0 in the previous frame buffer PF during the horizontal display time Thd in the vertical display time Tvd (referring to the step S240 and FIG. 6E). Since the frame image F3 is different to the previous frame image F0, the controller 122 outputs a comparison result S4 to corresponding pixels of the display panel 110, and the display panel 110 starts to display the area image A3. Since now the area image A1 has been continually displayed for three frame periods T1, and the area image A2 has been continually displayed for two frame periods T1, the color of the area image A3 is lighter than that of the area image A2, and the color of the area image A2 is lighter than that of the area image A1.

Then, as shown in FIG. 6E, after a time period of about (T0−2*T1) is passed (the period T0 (about 260 ms) is passed from FIG. 6A-FIG. 6E), the observer may view the area image A1 of the black color, the area image A2 of a deep gray color and the area image A3 of a light gray color. In other words, after the period T0 is passed, the area image A1 on the display panel 110 is in the stable state. Since a time recorded by the frame counter corresponding the frame image F1 is equal to the period T0, i.e. the area image A1 has been continually displayed for the period T0, the controller 122 may execute a step S270. As shown in FIG. 6E, in the step S270, the controller 122 copies the black area image A1 from the current frame buffer CF to the previous frame buffer PF during the vertical non-display time Tvb. Then, the controller 122 executes a step S280 to idle the queue Q1 and clear the frame counter corresponding frame image F1. According to the above descriptions, it is known that before the step S270 is executed, the controller 122 first determines whether the time recorded by the frame counter corresponding the frame image F1 is equal to the period T0, and then it is determined whether the steps S270 and S280 are required to be executed.

Similarly, during the horizontal display time Thd in the vertical display time Tvd, the controller 122 compares all image pixels in the current frame buffer CF and the previous frame buffer PF, and if data values of the corresponding pixels are the same, the corresponding displayed image is maintained unchanged (i.e. the 0V driving waveform is transmitted to the display panel 110). If data values of the corresponding pixels are different, the look-up table 126 is used to transmit the driving waveform (for example, the +15V driving waveform) of the corresponding address to the display panel 110. As shown in FIG. 6F, after about a frame period T1 when the period T0 is passed, the observer views the area image A1 of the black color, the area image A2 of the black color and the area image A3 of the deep gray color. In other words, after a summation time of the period T1 and the frame period T1 (i.e. T0+T1) is passed, since a display time of the area image A2 reaches the period T0, the area image A2 on the display panel 110 is in the stable state.

Then, the controller 122 copies the black area image A2 from the current frame buffer CF to the previous frame buffer PF during the vertical non-display time Tvb (the step S270). Since now the time recorded by the frame counter corresponding to area image A2 is equal to the period T0, the controller 122 idles the queue Q2, and clears the corresponding frame counter (the step S280).

Deduced by analogy, during the horizontal display time Thd in the vertical display time Tvd, the controller 122 compares all image pixels in the current frame buffer CF and the previous frame buffer PF. If data values of the corresponding pixels are the same, the corresponding displayed image is maintained unchanged (i.e. the 0V driving waveform is transmitted to the display panel 110). If data values of the corresponding pixels are different, the look-up table 126 is used to transmit the driving waveform (for example, the +15V driving waveform) of the corresponding address to the display panel 110. As shown in FIG. 6G, after about another frame period T1, the observer may view the black area image A1, the black area image A2, and the black area image A3. In other words, after a summation time of the period T1 and two frame periods T1 (i.e. T0+2*T1) is passed, since a display time of the area image A3 reaches the period T0, the area image A3 on the display panel 110 is in the stable state.

Then, the controller 122 copies the black area image A3 from the current frame buffer CF to the previous frame buffer PF during the vertical non-display time Tvb (the step S270). Since now the time recorded by the frame counter corresponding to area image A3 is equal to the period T0, the controller 122 idles the queue Q3, and clears the corresponding frame counter (the step S280).

According to the above descriptions, since the driving device 120 of the present embodiment uses the queues Q1-Q3 to store the continuous area data D1-D3 and uses a pipeline method to drive the display panel 110, the display panel 110 can integrally and continually display three black area images A1-A3 (i.e. the area images A1-A3 in the stable state) by only spending a time of (T0+2*T1). Compared to the conventional bistable display that one period T0 is required for displaying each area image, and triple time is spend for continually displaying three area images, the display device 120 of the present embodiment can shorten the display time of the bistable display 100.

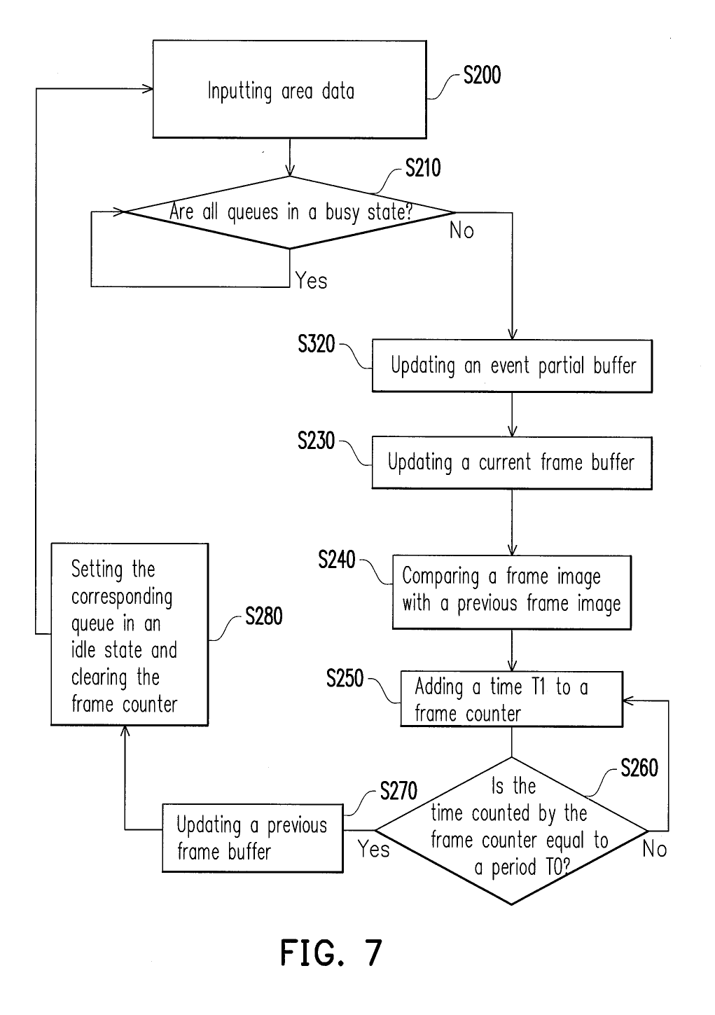

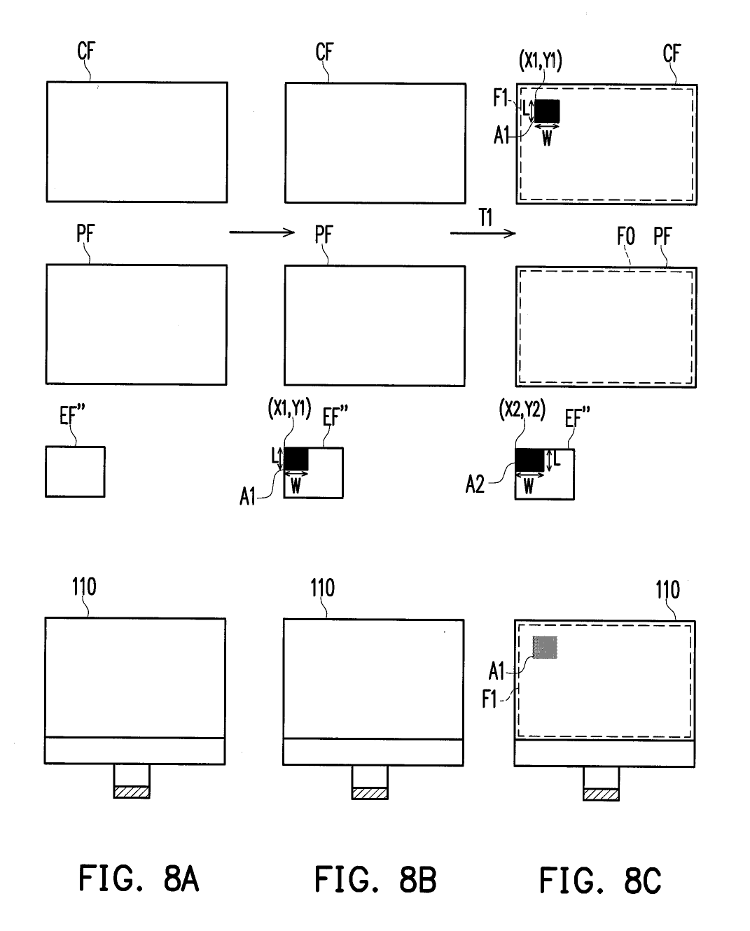

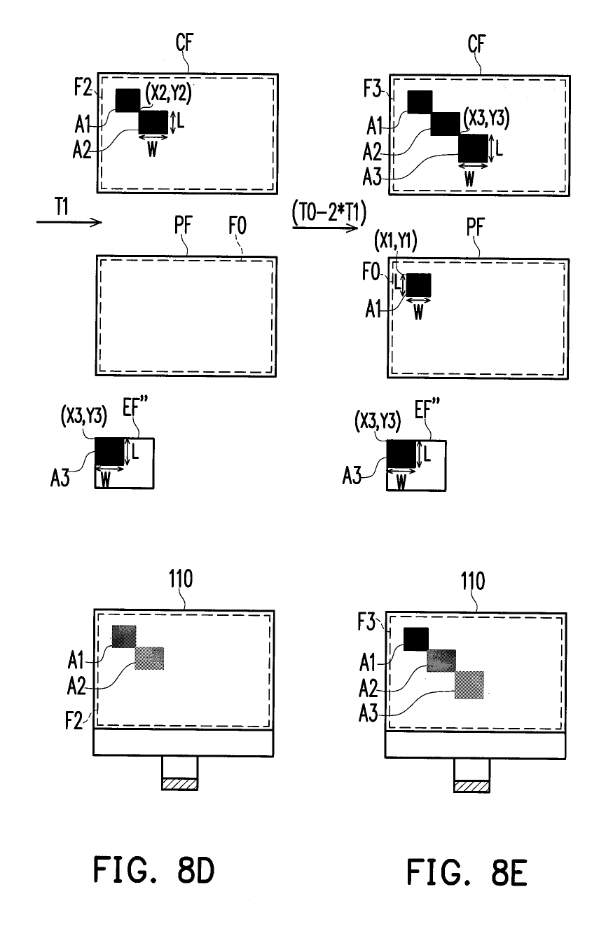

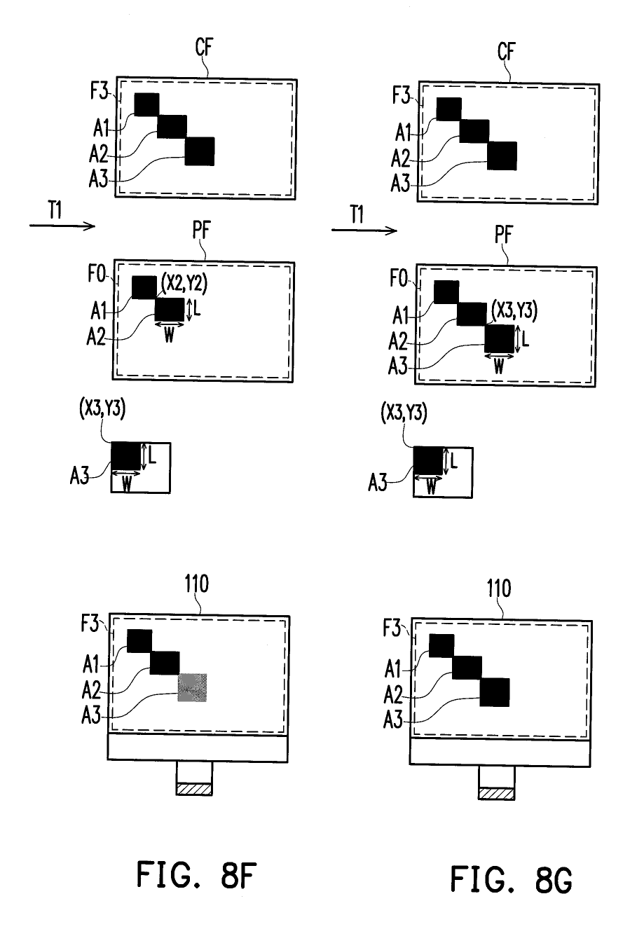

FIG. 7 is another flowchart illustrating a driving method of FIG. 3, and FIG. 8A to FIG. 8G are schematic diagrams of the driving method of FIG. 7. The flowchart of FIG. 7 is similar to that of FIG. 5, and a main difference there between is that the event buffer EF of FIG. 8A to FIG. 8G is an event partial buffer EF″, so that in a step S320 of FIG. 7, the controller 122 updates the event partial buffer EF″. In detail, a storage space of the event partial buffer EF″ is smaller than that of the event frame buffer EF′, and the event partial buffer EF″ can only store a part of the frame images F1-F3, for example, the area images A1-A3 of FIG. 8B-FIG. 8C. In other words, in the present embodiment, the event partial buffer EF″ is updated after each frame period T1.

In detail, as shown in FIG. 8B and FIG. 8C, when the controller 122 executes the step S320 of FIG. 7, the controller 122 deletes the area image A1 in the event partial buffer EF″, and stores the area image A2 in the event partial buffer EF″. Alternatively, as shown in FIG. 8C and FIG. 8D, the controller 122 deletes the area image A2 in the event partial buffer EF″, and stores the area image A3 in the event partial buffer EF″. Since those skilled in the art can learn enough instructions and recommendations of the driving method of FIG. 7 and FIG. 8A-FIG. 8G from the descriptions of the embodiment of FIG. 5 and FIG. 6A-FIG. 6G, detailed description thereof is not repeated.

Similarly, in the present embodiment, since only the first area image A1 displayed on the display panel 110 requires the period T0 (about 260 ms) to reach the stable state, the second area image A2 can reach the stable state after another frame period T1 (about 20 ms), and the third area image A3 can reach the stable state after still another frame period T1, a time for displaying the three area images A1-A3 is effectively shortened. For example, in the present embodiment, only the time of (T0+2*T1) is required to stably display the area images A1-A3, which is far less than the time of 3*T0 of the conventional technique.

In summary, in the embodiments of the invention, the queues are used to store the continuous area data and the pipeline method is used to drive the display panel. In this way, before the first area image reaches the stable state, the display panel may start to display the second area image, so as to shorten the whole image updating time.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A driving method, adapted to a bistable display comprising a display panel, the driving method comprising:
sequentially storing a respectively received first area data and a second area data in a first queue and a second queue, respectively;
sequentially calculating a first area image corresponding to the first area data and a second area image corresponding to the second area data; and
displaying the first area image on the display panel during a first frame period of a first period, and displaying the second area image on the display panel during a second frame period of the first period, wherein after the first period is passed, the first area image on the display panel is in a stable state, and after a summation time of the first period and the second frame period is passed, the second area image on the display panel is in the stable state.

2. The driving method as claimed in claim 1, wherein the step of displaying the first area image on the display panel during the first frame period of the first period comprises:
storing the first area image into an event buffer;
copying the first area image to a current frame buffer to form a first frame image; and
comparing the first frame image with a previous frame image to display the first area image on the display panel according to a first comparison result during the first frame period.

3. The driving method as claimed in claim 2, wherein the step of displaying the second area image on the display panel during the second frame period of the first period comprises:
updating the event buffer according to the second area image;
copying the second area image to the current frame buffer to form a second frame image, wherein the second frame image comprises the first area image and the second area image; and
comparing the first frame image with the previous frame image to display the second area image on the display panel according to a second comparison result during the second frame period.

4. The driving method as claimed in claim 3, wherein the step of updating the event buffer according to the second area image comprises storing the second area image into the event buffer.

5. The driving method as claimed in claim 4, wherein the step of updating the event buffer according to the second area image comprises deleting the first area image in the event buffer.

6. The driving method as claimed in claim 3, wherein the previous frame image is stored in a previous frame buffer.

7. The driving method as claimed in claim 6, further comprising:
after the first period is passed, copying the first area image to the previous frame buffer to update the previous frame buffer; and
after the summation time of the first period and the second frame period is passed, copying the second area image to the previous frame buffer to update the previous frame buffer.

8. The driving method as claimed in claim 2, wherein when the first frame image is different to the previous frame image, the first comparison result is output according to a look-up table.

9. The driving method as claimed in claim 1, further comprising setting the first queue to an idle state.

10. The driving method as claimed in claim 1, wherein the first period is an integer multiple of the first frame period.

11. The driving method as claimed in claim 1, wherein the first area data comprises at least one of start point coordinates, an image width, an image length and image pixels of the first area image.

12. A driving device, adapted to a bistable display comprising a display panel, the driving device comprising:
a first queue;
a second queue; and
a controller, for sequentially storing a respectively received first area data and a second area data in the first queue and the second queue, respectively, and sequentially calculating a first area image corresponding to the first area data and a second area image corresponding to the second area data, the controller controlling the display panel to display the first area image during a first frame period of a first period, and controlling the display panel to display the second area image during a second frame period of the first period, wherein after the first period is passed, the first area image on the display panel is in a stable state, and after a summation time of the first period and the second frame period is passed, the second area image on the display panel is in the stable state.

13. The driving device as claimed in claim 12, further comprising a memory coupled to the controller, wherein the memory comprises:
an event buffer, storing the first area image; and
a current frame buffer, wherein the controller copies the first area image to the current frame buffer to form a first frame image, and the controller compares the first frame image with a previous frame image to display the first area image on the display panel according to a first comparison result during the first frame period.

14. The driving device as claimed in claim 13, wherein the controller updates the event buffer according to the second area image, and copies the second area image to the current frame buffer to form a second frame image, wherein the second frame image comprises the first area image and the second area image, the controller compares the second frame image with the previous frame image to display the second area image on the display panel according to a second comparison result during the second frame period.

15. The driving device as claimed in claim 14, wherein the controller stores the second area image in the event buffer.

16. The driving device as claimed in claim 15, wherein the controller deletes the first area image in the event buffer.

17. The driving device as claimed in claim 14, wherein the memory further comprises a previous frame buffer, and the previous frame image is stored in the previous frame buffer.

18. The driving device as claimed in claim 17, wherein after the first period is passed, the controller copies the first area image to the previous frame buffer to update the previous frame buffer, and after the summation time of the first period and the second frame period is passed, the controller copies the second area image to the previous frame buffer to update the previous frame buffer.

19. The driving device as claimed in claim 13, further comprising a look-up table, wherein when the first frame image is different to the previous frame image, the controller outputs the first comparison result according to the look-up table.

20. The driving device as claimed in claim 12, wherein the controller further sets the first queue to an idle state.

21. The driving device as claimed in claim 12, wherein the first area data comprises at least one of start point coordinates, an image width, an image length and image pixels of the first area image.

22. The driving device as claimed in claim 12, wherein the first period is an integer multiple of the first frame period.

23. A bistable display comprising the driving device as claimed in claim 12.

24. The driving device as claimed in claim 22, wherein the bistable display is an e-paper display.
